(19) United States
(12) Patent Application Publication
(10) Pub. No.: US 2020/0214941 A1
(43) Pub. Date: Jul. 9, 2020

(54) COMFORT AID

(71) Applicant: DUMFORTER LTD, Bagshot (GB)

(72) Inventors: Johanne Margaret HOLMAN, Bagshot (GB); David FOWLER, London (GB)

(21) Appl. No.: 16/626,854

(22) PCT Filed: Jun. 29, 2018
(86) PCT No.: PCT/GB2018/051846

§ 371 Date: Dec. 26, 2019

(30) Foreign Application Priority Data
Jun. 29, 2017 (GB) 1710451.4

(51) Int. Cl. A61J 17/02; A61J 17/00

(52) U.S. Cl. CPC A61J 17/02; A61J 17/008; A61J 17/007

(57) ABSTRACT

The invention provides a comfort aid (10) for a baby, toddler, or child, wherein the comfort aid (10) comprises a soother (11) and a fascia (12). The soother comprises a shield (20) and the fascia (12) overlies at least a part of the shield (20). The fascia (12) is configured to grip at least a part of an edge of the shield (20).

### CROSS-REFERENCE TO RELATED APPLICATIONS

This application is a national stage entry under 35 U.S.C. 371 of PCT Patent Application No. PCT/GB2018/051846, filed Jun. 29, 2018, which claims priority to United Kingdom Patent Application No. 1710451.4, filed Jun. 29, 2017, the entire contents of each of which are incorporated herein by reference.

### TECHNICAL FIELD

The present invention relates to a comfort aid for a baby, toddler, or child.

### BACKGROUND

A number of types of comfort aid are commonly used to soothe and aid sleep in babies, toddlers, and children. One such comfort aid is a soother, also known as a ‘pacifier’ or ‘dummy’. Other known comfort aids include comforters and teethers. Comforters typically comprise a soft piece of fabric to be held or stroked. Teethers are used as a soothing tool for inflamed gums during teething.

### SUMMARY

In a first aspect, the present invention provides a comfort aid for a baby, toddler, or child, wherein the comfort aid comprises a soother and a fascia; wherein the soother comprises a shield and the fascia overlies at least a part of the shield; and the fascia is configured to grip at least a part of an edge of the shield.

Preferably, the fascia is a teether.

Preferably, the fascia comprises a resiliently deformable material.

Preferably, the fascia comprises one or more raised elements.

Preferably, the one or more raised elements comprise one or more nodules or ridges.

Preferably, the fascia comprises a perimeter flange configured to grip the edge of the shield.

Preferably, the fascia encapsulates the shield.

Preferably, the fascia comprises a first fascia portion and a second fascia portion.

Preferably, the first fascia portion is a first teether portion and the second fascia portion is a second teether portion.

Preferably, the second fascia portion extends from a teat of the soother.

Preferably, a distal edge of the first fascia portion is adhered to a distal edge of the second fascia portion.

Preferably, the fascia is detachable from the soother.

Preferably, the soother comprises a pivotable handle, wherein the pivotable handle has a first position in which the fascia is removable from the soother.

Preferably, the pivotable handle has multiple positions other than the first position, in which the fascia is secured to the soother.

Preferably, the comfort aid further comprises a detachable comforter.

Preferably, the comforter comprises attachment means for attachment to the soother.

Preferably, the soother comprises a detachable teat cap.

In a second aspect, the present invention provides a toy having a head and a body, wherein the head comprises the comfort aid of the present invention and the body comprises the comforter.

In a third aspect, the present invention provides a soother comprising: a shield; and a hub comprising a hub body and a hub fascia; wherein the shield comprises a protrusion; the hub body comprises at least one aperture; and the hub fascia comprises at least one compressible tang for snap-fit engagement with the aperture, the tang comprising a slot; wherein the shield, the hub body, and the hub fascia are assembled such that the protrusion extends into the slot to prevent compression of the tang.

### BRIEF DESCRIPTION OF THE DRAWINGS

Preferred embodiments of the present invention will now be described, by way of example only, with reference to the accompanying drawings, in which:

FIG. 1 is a front plan view of a comfort aid according to a first embodiment of the present invention;

FIG. 2 is a rear plan view of the comfort aid of FIG. 1;

FIG. 3 is a front plan view of a soother forming part of the comfort aid of FIG. 1;

FIG. 4 is a rear perspective view of the soother of FIG. 3;

FIGS. 5 to 9 are perspective views of elements of the soother of FIGS. 3 and 4;

FIG. 10 is a cross-sectional view of the comfort aid of FIG. 1;

FIG. 11 is a front plan view of a teether forming part of the comfort aid of FIG. 1;

FIG. 12 is a rear perspective view of the teether of FIG. 11;

FIG. 13 is a front perspective view of a teat cap for the comfort aid of FIG. 1;

FIG. 14 is a rear perspective view of the teat cap of FIG. 13;

FIG. 15 is a front perspective view of the comfort aid of FIG. 1 having an attached comforter;

FIG. 16 is a rear perspective view of the comfort aid and attached comforter of FIG. 15;

FIG. 17 is a front plan view of a comfort aid according to a second embodiment of the present invention;

FIG. 18 is a rear plan view of the comfort aid of FIG. 17;

FIG. 19 is a cross-sectional view of the comfort aid of FIG. 17;

FIG. 20 is an exploded perspective view of the comfort aid of FIG. 17;

FIG. 21 is a front perspective view of a first teether portion forming part of the comfort aid of FIG. 17;

FIG. 22 is a rear perspective view of the first teether portion of FIG. 21;

FIG. 23 is a front perspective view of a teat and a second teether portion forming part of the comfort aid of FIG. 17;

FIG. 24 is a rear perspective view of the teat and second teether portion of FIG. 23.

### DETAILED DESCRIPTION

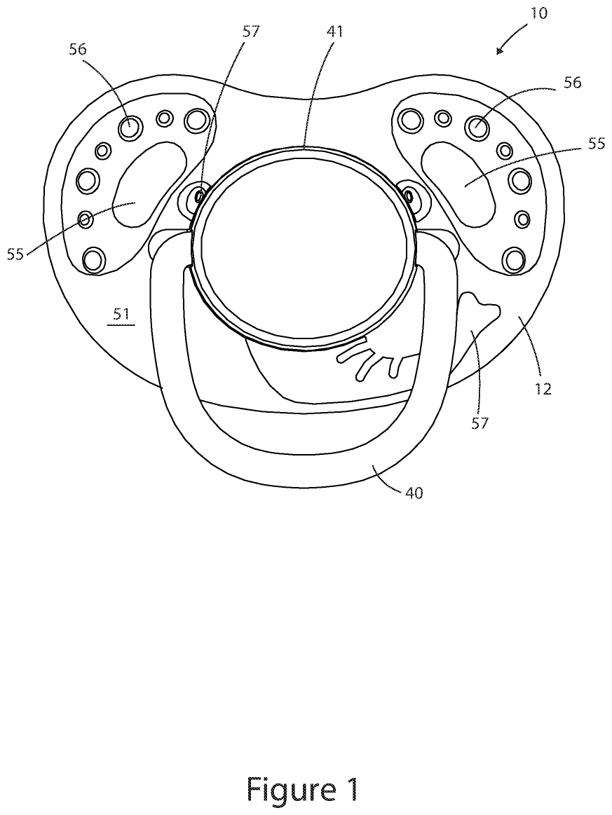

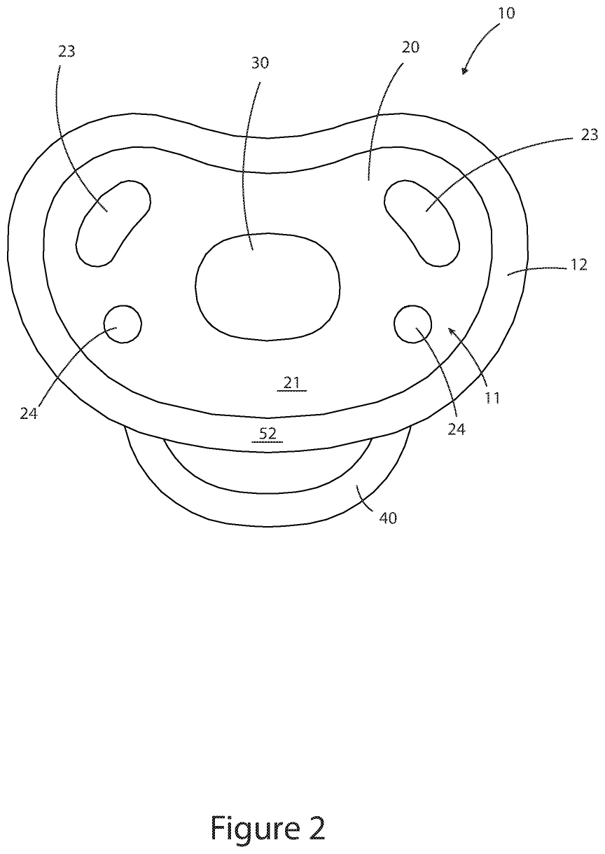

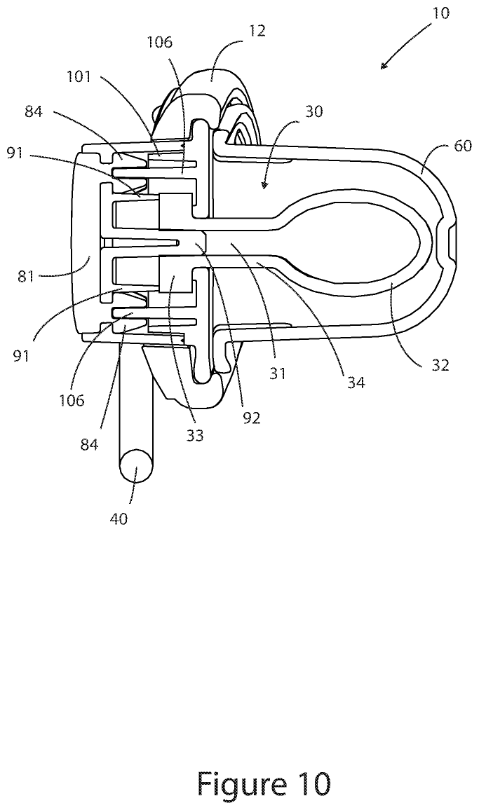

FIGS. 1 and 2 illustrate a comfort aid 10 according to a first embodiment of the present invention (shown in cross-section in FIG. 10). The comfort aid 10 comprises two base components: a soother 11 and a teether 12. A teether 12 may be generally defined as an object made of a resiliently deformable material, sized and shaped such that it may be gummed by a teething baby, toddler, or child.

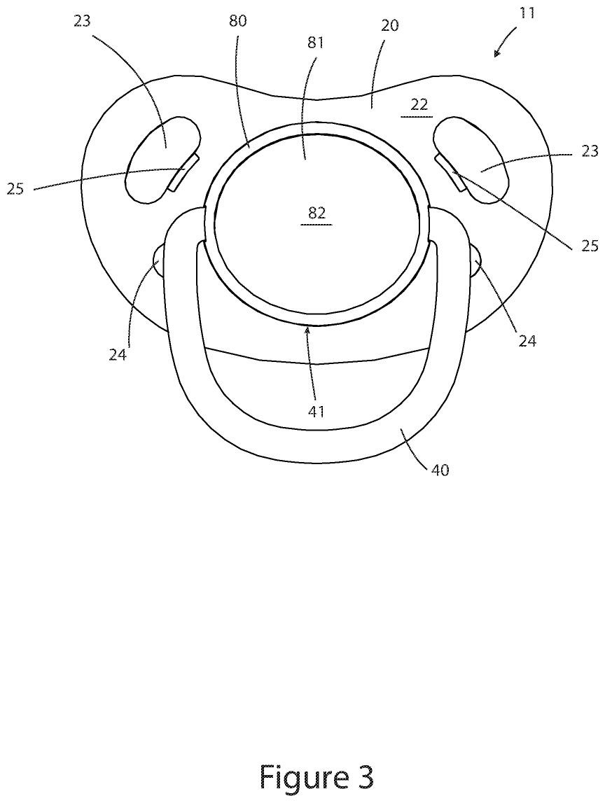

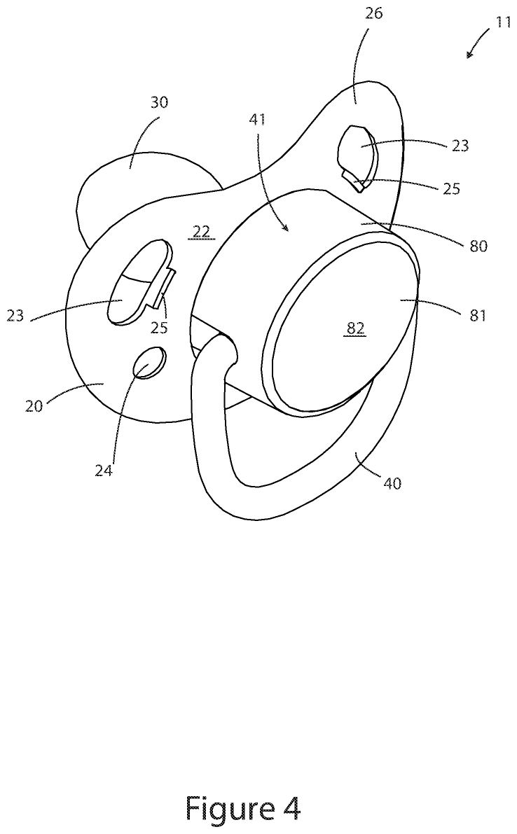

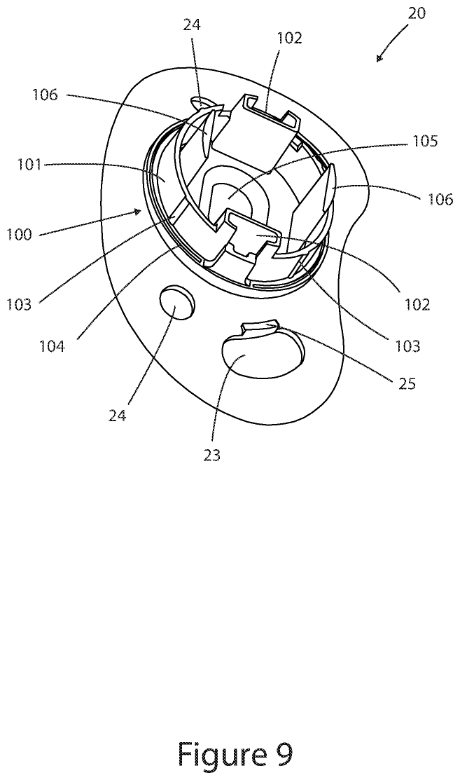

The soother 11 is illustrated in greater detail in FIGS. 3 and 4. The soother 11 may comprise a shield 20 (also shown in FIG. 9) having a first surface 21 and a second surface 22 opposing the first surface 21. The shield 20 may be generally kidney-shaped. Alternatively, other suitable shapes of the shield 20 are envisaged, such as a circle, ellipse, oval, or waisted-oval. The shield 20 may be flat, or may have a curvature, for example such that the shield 20 may sit generally flush against a baby's, toddler's, or child's face. The shield 20 may be provided with one or more airflow apertures 23 to improve airflow to a part of a baby's, toddler's, or child's face which may be covered by the shield 20. For example, a pair of airflow apertures 23 may be positioned symmetrically about a vertical centre-line of the shield 20 when in use. A flange 25 may extend from the second surface 22 at an edge of the one or more airflow apertures 23. The shield 20 may be provided with one or more alignment features 24. For example, a pair of alignment features 24 may be positioned symmetrically about a vertical centre-line of the shield 20 when in use. The one more alignment features 24 may, for example, comprise one or more apertures or dimples in the second surface 22. The second surface 22 may be further provided with a perimeter ridge 26 having a depth greater than the flange 25.

A central region 100 of the second surface 22 of the shield 20 may comprise a substantially annular wall 101 extending away from the second surface 22. The annular wall 101 may be provided with two slot regions 102. An exterior surface of the annular wall 101 may be provided with one or more zero tolerance ribs 103. A ridge 104 may be provided on the second surface 22 around at least a part of the annular wall 101. Within the annular wall 101, the central region 100 may comprise a central aperture 105 and one or more projections 106 that may extend away from the second surface 22.

A teat 30 may extend from the first surface 21 of the shield 20. The teat 30 may be sized and shaped for sucking by a baby, toddler, or child, as is well known in the art. The teat 30 may be made of silicone, latex, or any other suitable material. The teat 30 may be hollow (as shown in FIG. 10), and may comprise an opening 31 distal from a sucking portion 32 of the teat 30. The opening 31 may be provided with an annular flange 33 extending away from the teat 30. A neck portion 34, which may be narrower than the sucking portion 32, may be provided between the sucking portion 32 and the annular flange 33.

A handle 40 may be pivotally connected to the second surface 22 of the shield 20. As illustrated, the handle 40 may be pivotally connected to a hub 41 extending from the second surface 22. A maximum width of the handle 40 may be greater than a maximum width of the hub 41.

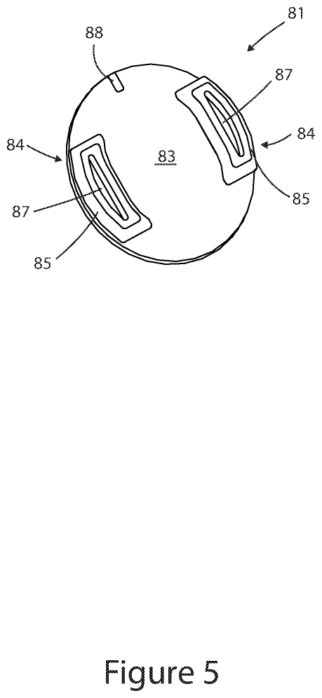

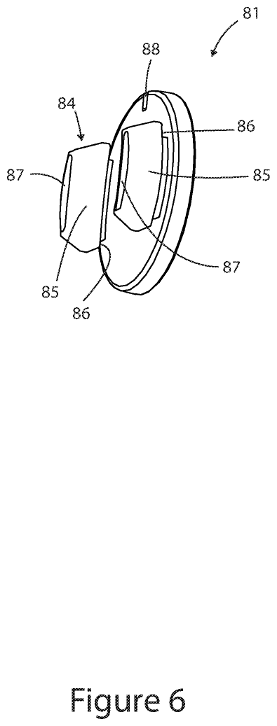

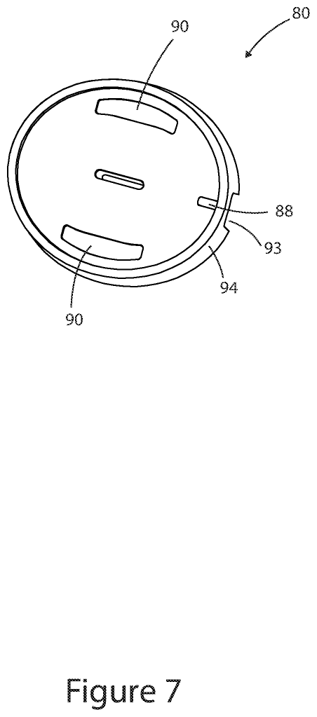

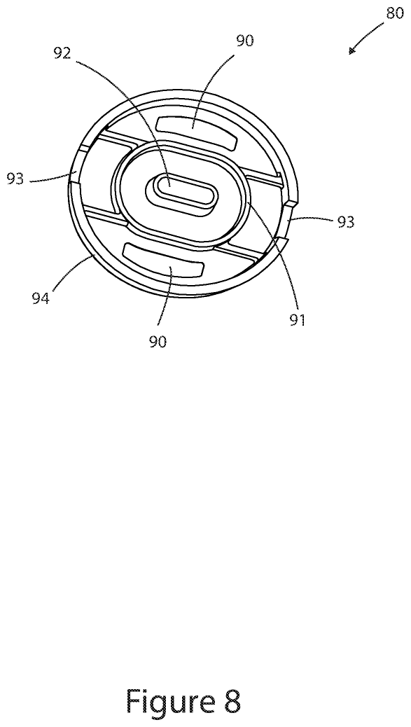

The hub 41 may comprise a hub body 80 (shown in FIGS. 7 to 8) and a hub fascia 81 (shown in FIGS. 5 to 6). A first surface 82 of the hub fascia 81 may comprise design elements (not shown). The hub fascia 81 may be coupled to the hub body 80 via a permanent cantilever snap-fit connection. To enable this, a second surface 83 of the hub fascia 81, opposing the first surface 82, may comprise one or more tangs 84. The one or more tangs 84 may have oblique entrance sides 85, such that the tang 84 tapers towards a distal end of the tang 84. The one or more tangs 84 may have blunt retraction sides 86, to form a blunt catch to provide the permanent snap-fit connection. In an alternative embodiment, the one or more tangs 84 of the hub fascia 81 may be provided with rounded retraction sides (not shown), to instead provide a releasable snap-fit connection with the hub body 80. The distal end of the one or more tangs 84 may comprise a slot 87 that may penetrate into a depth of the tang 84, the slot 87 allowing compression of the distal end of the tang 84. The hub fascia 81 and the hub body 80 each may be provided with a complementary orientation key 88 to aid the assembly the two parts.

The hub body 80 may be provided with one or more apertures 90 for receiving the one or more tangs 84 of the hub fascia 81. An interior of the hub body 80 may be provided with an annular projection 91, within which there may be a central projection 92. Two slots 93 may be provided in a side wall 94 of the hub body 80, to accommodate the handle 40.

The shield 20 and the hub body 80 may be made of polypropylene, or any other suitable material. The hub fascia 81 may be made of silicone rubber, or any other suitable material.

The hub 41 may thus be assembled by inserting the one or more tangs 84 of the hub fascia 81 though the one or more apertures 90 of the hub body 80. The slots 87 in the one or more tangs 84 allow the tang 84 to pass through the smaller aperture 90, to achieve the snap-fit connection. The orientation keys 88 on the hub fascia 81 and the hub body 80 aid in orientating the two parts prior to insertion of the tangs 84. In an alternative embodiment, the hub 41 may comprise a single element.

To assemble the soother 11, the teat 30 may be mated with the shield 20 such that the neck portion 34 of the teat 30 sits within the central aperture 105 of the shield 20, with the annular flange 33 lying substantially against the second surface 22 of the shield 20. Opposing ends of the handle 40 may be slotted into the two slot regions 102 of the annular wall 101 of the central region 100 of the second surface 22 of the shield 20. The hub 41 may then be mated to the shield 20 by fitting the side wall 94 of the hub body 80 around the annular wall 101 of the central region 100, with the two slots 93 of the hub body 80 corresponding with the two slot regions 102 of the annular wall 101. As this occurs, the central projection 92 of the hub body 80 may extend into the opening 31 of the teat and exert an outward force on it, with the annular projection 91 of the hub body 80 contacting the annular flange 33 of the teat, thereby securing the teat 30 to the shield 20. The one or more projections 106 may extend into the slots 87 of the one or more tangs 84 of the hub fascia 81 and exert an outward force on them, to further secure the connection between the hub fascia 81 and the hub body 80. The side wall 94 of the hub body may sit over the ridge 104 provided around at least a part of the annular wall 101. The one or more zero tolerance ribs 103 may aid in achieving a friction fit between the side wall 94 of the hub body 80 and the annular wall 101 of the central region 100. Complementary orientation keys (not shown) may be provided on the shield 20 and the hub body 80 to aid in orientating the two parts when mating them. Finally, the hub 41 may be welded to the shield 20 by any suitable method. For example, high frequency welding (also known as radio frequency welding) may be used, during which the ridge 104 may melt to form the weld.

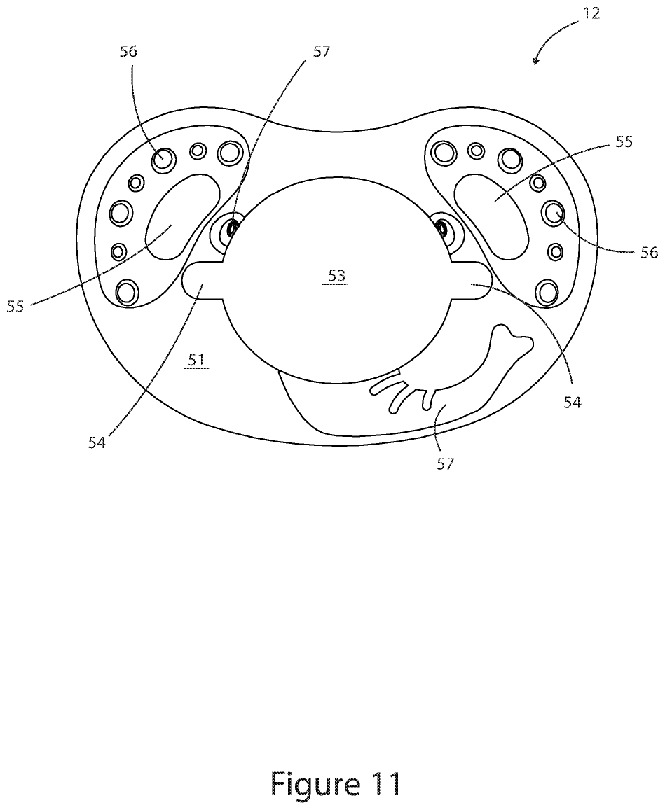

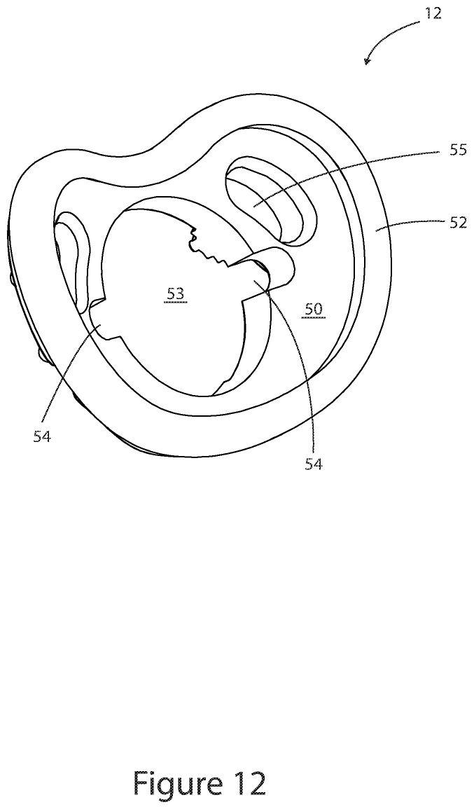

The teether 12 is illustrated in greater detail in FIGS. 11 and 12. The teether 12 may be made of silicone rubber, or any other suitable material. Preferably, the teether 12 may be made of a material having a Shore A hardness of 40-100, more preferably 60-80, more preferably 70. The teether 12 may be configured to be attachable to, and detachable from, the soother 11. The teether 12 may be configured to overlie at least a part of the shield 20 of the soother 11. The shape and size of the teether 12 may generally correspond with the shape and size of the soother 11. The teether 12 may comprise a first surface 50 and a second surface 51 opposing the first surface 50. A perimeter flange 52 may extend from an outer edge of the first surface 50, and may fold inwardly towards a centre-point of the first surface 50. The first surface 50 of the teether 12 and the perimeter flange 52 may be shaped and sized to fit over the second surface 22 of the shield 20 of the soother 11, such that the perimeter flange 52 may grip the shield 20 of the soother 11 for retaining the teether 12 on the shield 20. The teether 12 may be provided with an aperture 53 configured to fit around the hub 41 from the second surface 22 of the soother 11. A pair of slots 54 may extend from the aperture 53, the slots 54 being configured to enable passage of the handle 40 therethrough. The teether 12 may be provided with one or more airflow apertures 55 which may correspond with the one or more airflow apertures 23 of the soother 11.

The second surface 51 of the teether 12 may be provided with one or more raised elements 56 such as nodules or ridges. The second surface 51 may be further provide with design elements 57. The design elements 57 may be flush with the second surface 51, for example printed design elements, or they may be in relief.

Whilst a teether 12 has been described above, the described constructional details may be applied to any form of fascia 12. It may be the case that the fascia 12 does not comprise a reliantly deformable material. The fascia 12 may be made of polypropylene, or another suitable material.

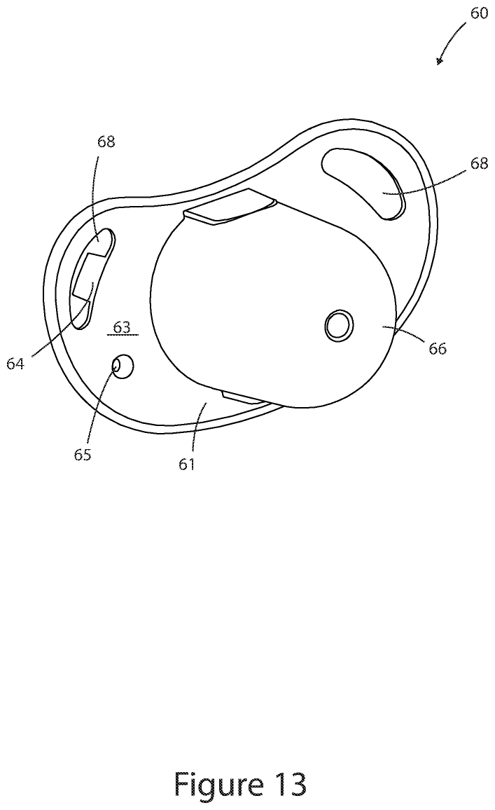

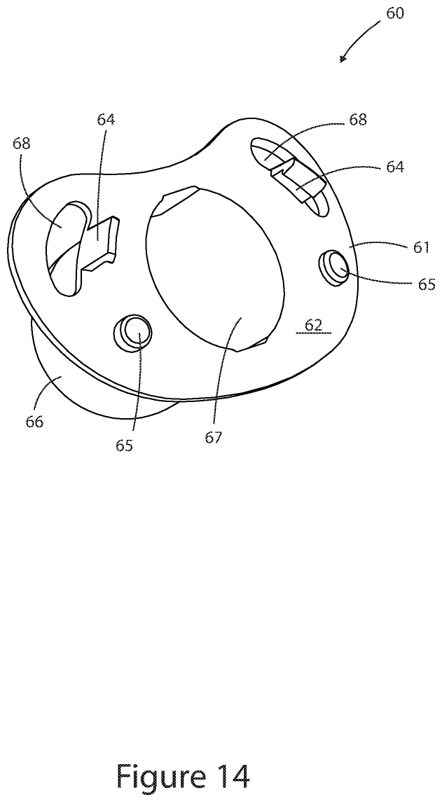

A removable teat cap 60, as illustrated in FIGS. 13 and 14, may be provided such that the teat 30 of the soother 11 may be protected from dirt when not in use. The teat cap 60 may comprise a base element 61 having a first surface 62 and a second surface 63 opposing the first surface 62. The first surface 62 of the base element 61 may be configured to contact the first surface 21 of the shield 20 of the soother 11, and may be shaped and sized accordingly. One or more hooked projections 64 may extend from the first surface 62 of the base element 61, the one or more hooked projections 64 being configured to pass through the one or more airflow apertures 23 in the shield 20 and to grip the flange 25 at the edge of the one or more airflow apertures 23. One or more alignment features 65 may be provided on the first surface 62 of the base element 61, to correspond with the one or more alignment features 24 on the second surface 22 of the soother 11. For example, where the one or more soother alignment features 24 comprise apertures or dimples, the one or more teat cap alignment features 65 may comprise complementary projections.

A hollow enclosure 66 may project from the second surface 63 of the base element 61 of the teat cap 60, around an aperture 67. The hollow enclosure 66 may be configured to fit around the teat 30 of the soother 11. Preferably, clearance is provided between the teat 30 and the hollow enclosure 66.

One or more airflow apertures 68 may be provided in the base element 61 of the teat cap 60, although these are not required.

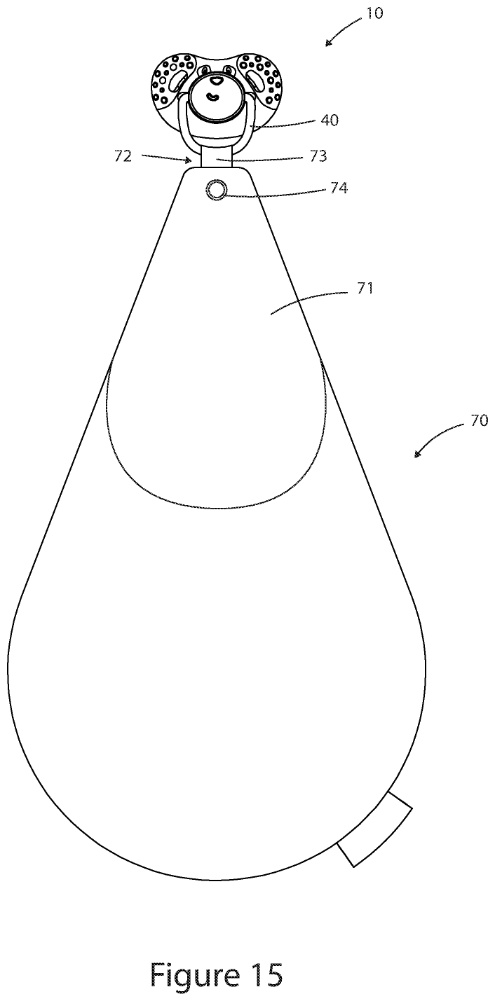

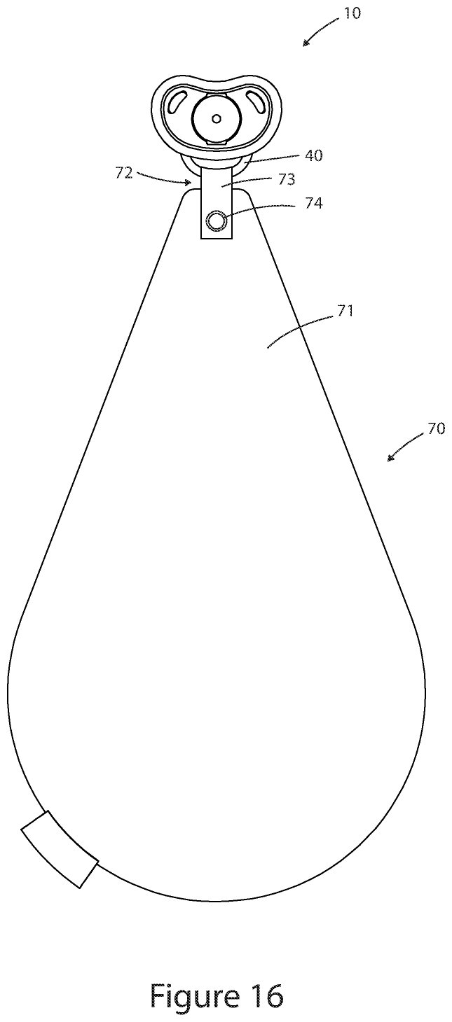

A comforter 70 (illustrated in FIGS. 15 and 16) may be provided, which may be configured for attachment to the handle 40 of the soother 11. The comforter 70 may comprise a piece of fabric 71, suitable for comforting a baby, toddler, or child. The fabric 71 may comprise one or more layers, which may differ from each other. For example, the fabric 71 may be soft and/or silky. The comforter 70 may comprise attachments means 72 for attaching the comforter 70 to the handle 40 of the soother 11. The attachment means 72 may, for example, comprise a tag 73 having a proximal end attached to the fabric 71 and a distal end attachable to the fabric via securing means 74, such that the tag 73 may form a loop around the handle 40 of the soother 11. The securing means 74 may, for example, comprise press studs (also known as ‘poppers), complementary magnets, or complementary pieces of a hook-and-loop material, such as Velcro®. One or both sides of the fabric 71 may comprise a design.

In use, the handle 40 of the soother 11 may be moved to a first position, substantially perpendicular to the shield 20 of the soother. With the handle 40 in the first position, the teether 12 may be fitted to the soother 11 by passing the aperture 53 and slots 54 of the teether 12 over the hub 41 and handle 40 of the soother, and using the perimeter flange 52 to grip the shield 20 of the soother 11. The handle 40 of the soother 11 may then be moved to a position other than the first position, in which the teether 12 may not be able to pass over the handle 40 and therefore is secured to the soother 11. Due to the perimeter ridge 26 on the second surface 22 of the shield 20 of the soother 11, in the combined soother 11 and teether 12 assembly a gap (not shown) is provided between the second surface 22 of the shield 20 of the soother 11 and the first surface 50 of the teether 12. In some embodiments, However, in an alternative embodiment the teether 12 may be adhered to the shield 20, for example via an adhesive (for example, a medical grade adhesive such as an adhesive from the Dymax MD range of adhesives, available from Dymax Corporation), such that the teether 12 is not detachable from the soother 11.

To attach the comforter 70 to the combined soother 11 and teether 12, or to the soother 11 on its own, the distal end of the tag 73 may be passed through the handle 40 of the soother 11 and secured via the securing means 74.

The teat cap 60 may be fitted to the soother 11 by passing the one or more hooked projections 64 of the teat cap 60 through the one or more airflow apertures 23 of the soother 11, such that the one or more hooked projections 64 grips the corresponding one or more flanges 25 at the edge of the airflow aperture 23. The soother 11 alignment features 24 and the corresponding teat cap 60 alignment features 65 may also mate. When the teat cap 60 is fitted to the combined soother 11 and teether 12 assembly, the mated hooked projection 64 and flange 25 may sit within the gap provided between the second surface 22 of the shield 20 of the soother 11 and the first surface 50 of the teether 12.

The various components of the comfort aid 10 may be disassembled by reversing the above steps.

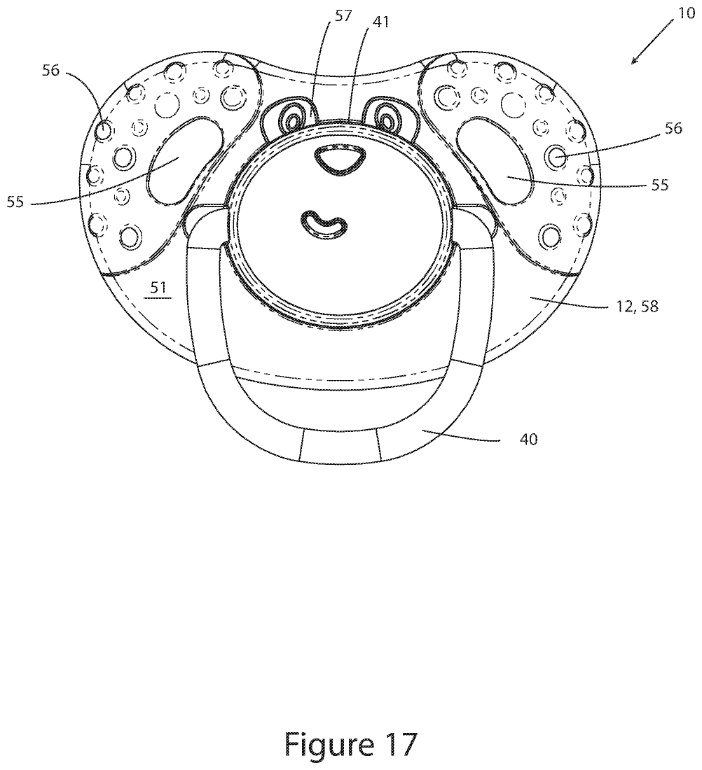

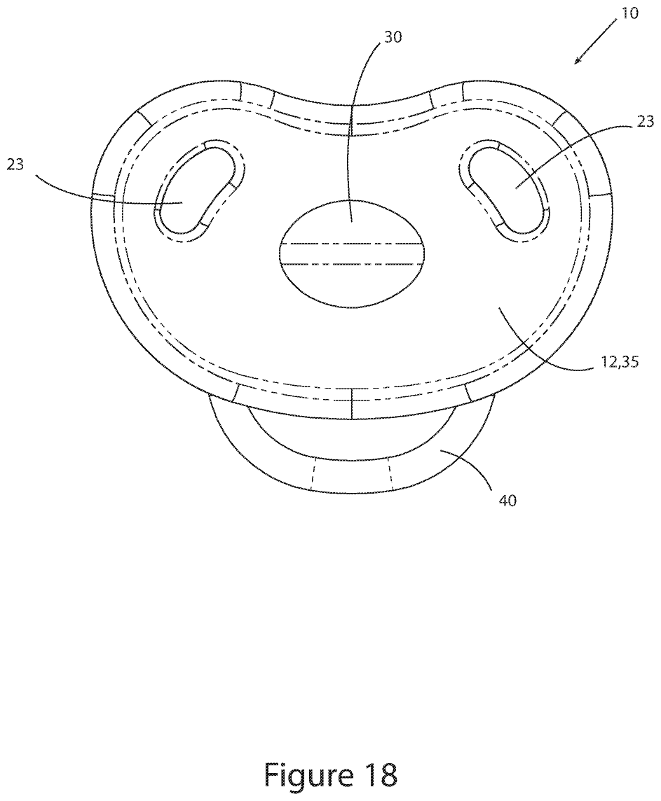

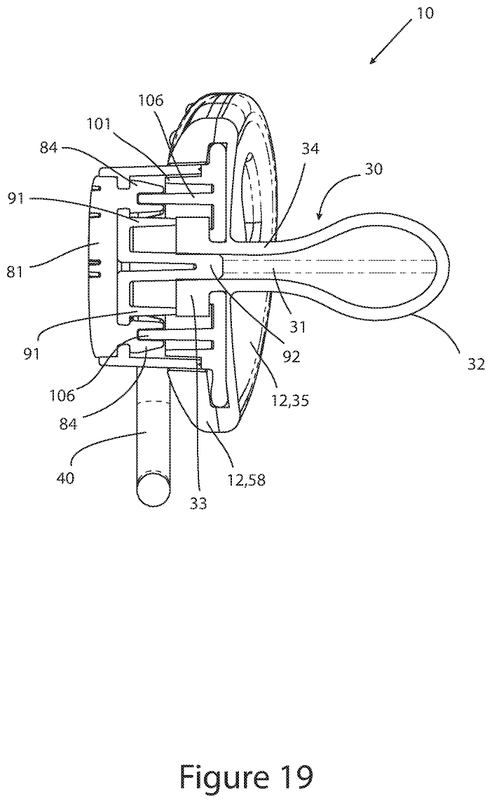

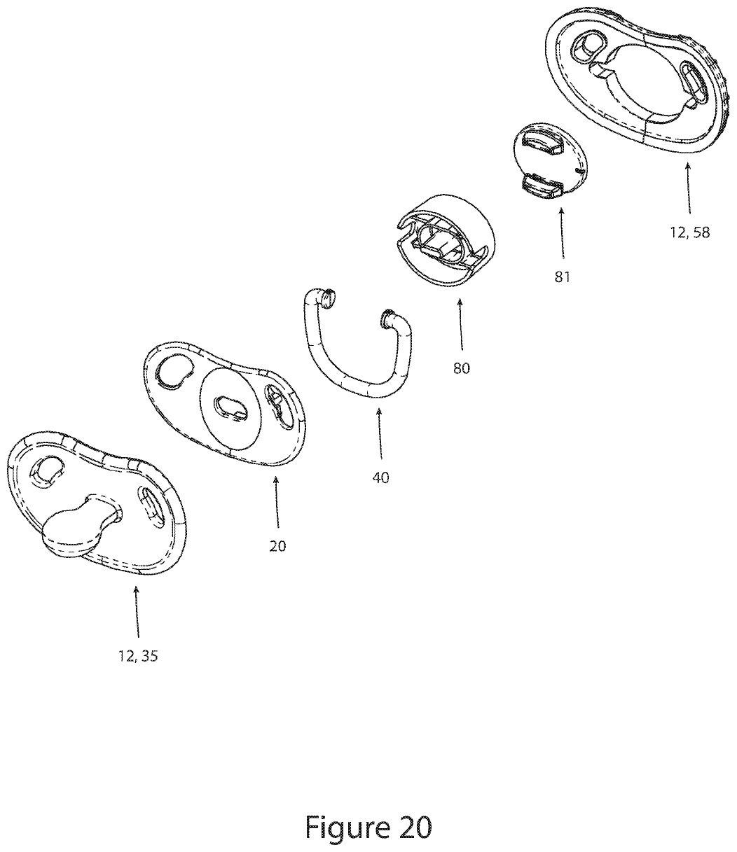

FIGS. 17 to 20 illustrate a comfort aid 10 according to a second embodiment of the present invention. The second embodiment may differ from the first embodiment in that the teether 12 may extend further around the first surface 21 of the shield 20. The teether 12 may encapsulate the shield 20. In the second embodiment, the teether 12 may not be detachable from the soother 11; instead, the teether 12 and the soother 11 of the second embodiment may be formed to be a single part.

The teether 12 of the second embodiment may comprise a first teether portion 58 and a second teether portion 35.

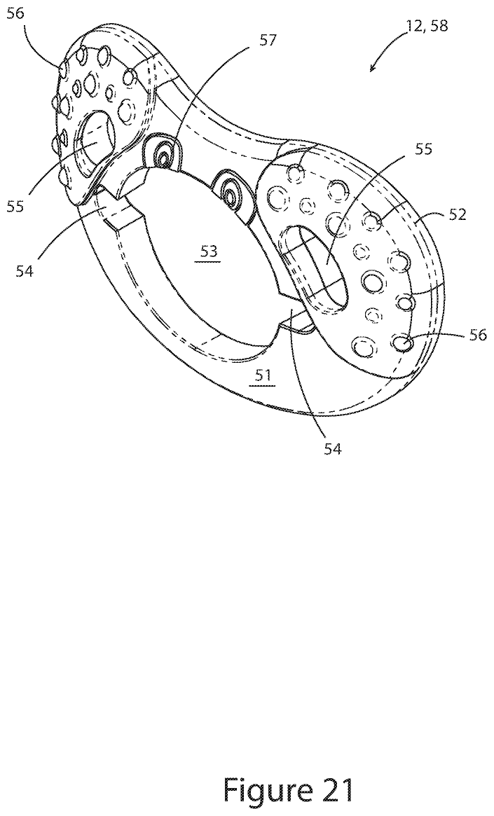

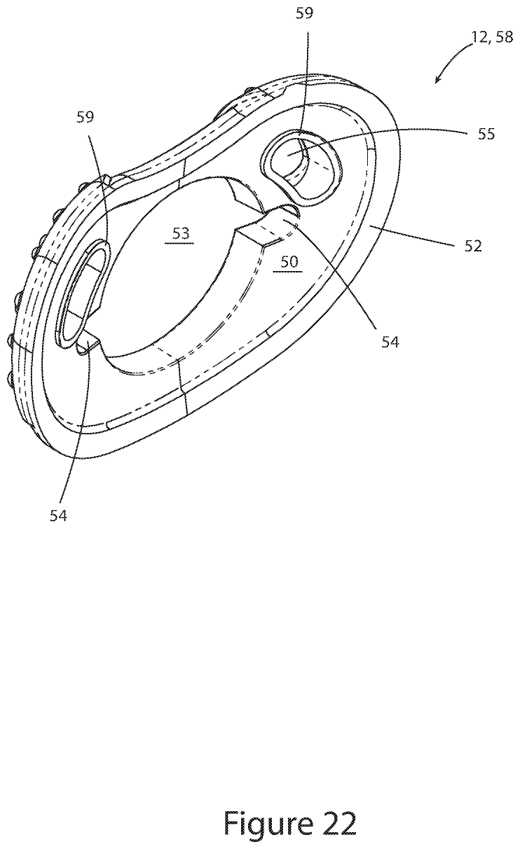

The first teether portion 58 (shown in FIGS. 21 and 22) may be generally similar to the teether 12 of the first embodiment. The first teether portion 58 may differ from the teether 12 of the first embodiment in that the perimeter flange 52 may only extend substantially orthogonally from the outer edge of the first surface 50 of the teether 12 (although an outer surface of the perimeter flange 52 may be curved), and may not fold inwardly towards a centre-point of the first surface 50 of the first teether portion 58. Additionally, each airflow aperture 55 of the first teether portion 58 may be provided with an aperture flange 59, which may extend substantially orthogonally from a perimeter of the airflow aperture 37 in a direction away from the first surface 50.

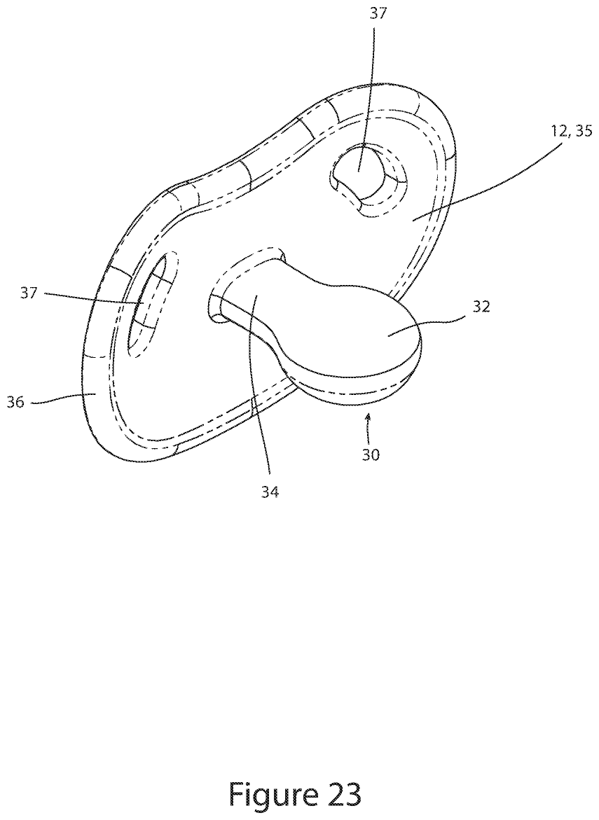

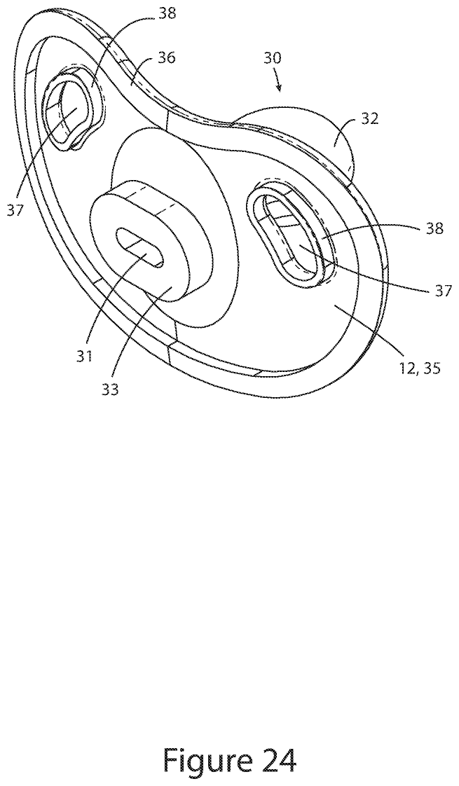

The second teether portion 35 (shown in FIGS. 23 and 24) may comprise a flanged portion extending from the neck portion 34 of the teat 30. The second teether portion 35 may extend substantially orthogonally from the neck portion 34. The second teether portion 35 may be positioned towards, but distanced from, the annular flange 33. The shape of the second teether portion 35 may generally correspond to the shape of the shield 20. A perimeter flange 36 may extend substantially orthogonally from an outer edge of the second teether portion 35 in the direction of the annular flange 33 (although an outer surface of the perimeter flange 36 may be curved). One or more airflow apertures 37 may be provided in the second teether portion 35, the airflow apertures 37 generally corresponding in location, size, and shape with the one or more airflow apertures 23 of the shield 20. Each airflow aperture 37 may be provided with an aperture flange 38, which may extend substantially orthogonally from a perimeter of the airflow aperture 37 in the direction of the annular flange 33.

Whilst a teether 12 has been described above in relation to the second embodiment, the described constructional details may be applied to any form of fascia 12. Like the teether 12, the fascia 12 may extend around the first surface 21 of the shield 20. The fascia 12 may encapsulate the shield 20. The fascia 12 may comprise a first fascia portion 58 and a second fascia portion 35. It may be the case that the fascia 12 does not comprise a reliantly deformable material. The fascia 12 may be made of polypropylene, or another suitable material.

The soother 11 of the second embodiment may comprise the same shield 20, handle 40, and hub 41 as described with respect to the first embodiment. The teat 30 of the second embodiment may comprise all of the features of the teat 30 of the first embodiment, with the addition of the second teether portion 35.

To assemble the comfort aid 10 of the second embodiment, the teat 30 may be mated with the shield 20 such that the neck portion 34 of the teat 30 sits within the central aperture 105 of the shield 20, with the annular flange 33 lying substantially against the second surface 22 of the shield 20. The second teether portion 35 may lie substantially against the first surface 21 of the shield 20, with the perimeter flange 36 of the second teether portion 35 sitting around a perimeter of the shield 20 and the one or more aperture flanges 38 of the second teether portion 35 sitting within the one or more airflow apertures 23 of the shield 20. Opposing ends of the handle 40 may be slotted into the two slot regions 102 of the annular wall 101 of the central region 100 of the second surface 22 of the shield 20. The hub 41 may then be mated to the shield 20 by fitting the side wall 94 of the hub body 80 around the annular wall 101 of the central region 100, with the two slots 93 of the hub body 80 corresponding with the two slot regions 102 of the annular wall 101. As this occurs, the central projection 92 of the hub body 80 may extend into the opening 31 of the teat and exert an outward force on it, with the annular projection 91 of the hub body 80 contacting the annular flange 33 of the teat, thereby securing the teat 30 to the shield 20. The one or more projections 106 may extend into the slots 87 of the one or more tangs 84 of the hub fascia 81 and exert an outward force on them, to further secure the connection between the hub fascia 81 and the hub body 80. The side wall 94 of the hub body may sit over the ridge 104 provided around at least a part of the annular wall 101. The one or more zero tolerance ribs 103 may aid in achieving a friction fit between the side wall 94 of the hub body 80 and the annular wall 101 of the central region 100. Complementary orientation keys (not shown) may be provided on the shield 20 and the hub body 80 to aid in orientating the two parts when mating them. The hub 41 may be welded to the shield 20 by any suitable method. For example, high frequency welding (also known as radio frequency welding) may be used, during which the ridge 104 may melt to form the weld.

The first teether portion 58 may then be fitted to the soother 11 by first moving the handle 40 of the soother 11 to a first position, substantially perpendicular to the shield 20 of the soother. With the handle 40 in the first position, the aperture 53 and slots 54 of the first teether portion 58 may be passed over the hub 41 and handle 40 of the soother 11, such that the first surface 50 of the first teether portion 58 lies substantially against the second surface 22 of the shield 20. The perimeter flange 52 of the first teether portion 58 may sit around the perimeter of the shield 20, and the one or more aperture flanges 58 of the first teether portion 58 may sit within the one or more airflow apertures 23 of the shield 20. Finally, the perimeter flange 36 and the one or more airflow apertures 37 of the second teether portion 35 may be adhered to the perimeter flange 52 and the one or more airflow apertures 58 of the teether 12. This may be done using an adhesive (for example, a medical grade adhesive such as an adhesive from the Dymax MD range of adhesives, available from Dymax Corporation), via a welding method (such as high frequency or ultrasonic welding), by compression moulding, or by any other suitable method.

In use, the comforter 70 may be attached to the soother 11 by passing the distal end of the tag 73 through the handle 40 of the soother 11, and securing the tag 73 via the securing means 74.

The combined assembly of the soother 11, teether 12, and comforter 70 may form a toy. For example, the toy may resemble a character having a head and a body, such as an animal or a person. In such an arrangement, the soother 11 and/or teether 12 may form the head of the character and the comforter 70 may form the body of the character. For example, the design elements 57 on the teether 12 may represent the ears of an animal, while the hub 41 of the soother 11 may be decorated to represent at least part of an animal's nose.

Embodiments of the invention are considered as set out in the following numbered clauses:

1. A comfort aid for a baby, toddler, or child, wherein the comfort aid comprises a soother having a detachable teether.

2. A comfort aid according to clause 1, wherein the teether comprises a resiliently deformable material.

3. A comfort aid according to clause 1 or clause 2, wherein the teether comprises one or more raised elements.

4. A comfort aid according to clause 3, wherein the one or more raised elements comprise one or more nodules or ridges.

5. A comfort aid according to any one of the preceding clauses, wherein the soother comprises a shield and the teether overlies at least a part of the shield.

6. A comfort aid according to clause 5, wherein the teether is configured to grip at least a part of an edge of the shield.

7. A comfort aid according to clause 6, wherein the teether comprises a perimeter flange configured to grip the edge of the shield.

8. A comfort aid according to any one of the preceding clauses, wherein the soother comprises a pivotable handle.

9. A comfort aid according to clause 8, wherein the pivotable handle has a first position in which the teether is removable from the soother.

10. A comfort aid according to clause 9, wherein the pivotable handle has multiple positions other than the first position, in which the teether is secured to the soother.

11. A comfort aid according to any one of the preceding clauses, further comprising a detachable comforter.

12. A comfort aid according to clause 11, wherein the comforter comprises attachment means for attachment to the soother.

13. A comfort aid according to any one of the preceding clauses, wherein the soother comprises a detachable teat cap.

14. A toy having a head and a body, wherein the head comprises the comfort aid of any one of clauses 1 to 10 and the body comprises the comforter of clause 11 or clause 12.

15. A soother comprising:

a shield; and

a hub comprising a hub body and a hub fascia; wherein

the shield comprises a protrusion;

the hub body comprises at least one aperture; and

the hub fascia comprises at least one compressible tang for snap-fit engagement

with the aperture, the tang comprising a slot; wherein

the shield, the hub body, and the hub fascia are assembled such that the protrusion extends into the slot to prevent compression of the tang.

16. A comfort aid according to any one of clauses 1 to 14 comprising the soother of clause 15.

1. A comfort aid for a baby, toddler, or child, wherein the comfort aid comprises a soother and a fascia; wherein
the soother comprises a shield and the fascia overlies at least a part of the shield; and
the fascia is configured to grip at least a part of an edge of the shield.

2. A comfort aid according to claim 1, wherein the fascia is a teether.

3. A comfort aid according to claim 1, wherein the fascia comprises a resiliently deformable material.

4. A comfort aid according to claim 1, wherein the fascia comprises one or more raised elements.

5. A comfort aid according to claim 4, wherein the one or more raised elements comprise one or more nodules or ridges.

6. A comfort aid according to claim 1, wherein the fascia comprises a perimeter flange configured to grip the edge of the shield.

7. A comfort aid according to claim 1, wherein the fascia encapsulates the shield.

8. A comfort aid according to claim 7, wherein the fascia comprises a first fascia portion and a second fascia portion.

9. A comfort aid according to claim 8, wherein the first fascia portion is a first teether portion and the second fascia portion is a second teether portion.

10. A comfort aid according to claim 8, wherein the second fascia portion extends from a teat of the soother.

11. A comfort aid according to claim 8, wherein a distal edge of the first fascia portion is adhered to a distal edge of the second fascia portion.

12. A comfort aid according to claim 1, wherein the fascia is detachable from the soother.

13. A comfort aid according to claim 12, wherein the soother comprises a pivotable handle, wherein the pivotable handle has a first position in which the fascia is removable from the soother.

14. A comfort aid according to claim 13, wherein the pivotable handle has multiple positions other than the first position, in which the fascia is secured to the soother.

15. A comfort aid according to claim 1, further comprising a detachable comforter.

16. A comfort aid according to claim 15, wherein the comforter comprises attachment means for attachment to the soother.

17. A comfort aid according to claim 1, wherein the soother comprises a detachable teat cap.

18. A toy having a head and a body, wherein the head comprises the comfort aid of claim 1 and the body comprises the comforter of claim 15.

19. A soother comprising:
a shield; and
a hub comprising a hub body and a hub fascia; wherein
the shield comprises a protrusion;
the hub body comprises at least one aperture; and
the hub fascia comprises at least one compressible tang for snap-fit engagement with the aperture, the tang comprising a slot; wherein
the shield, the hub body, and the hub fascia are assembled such that the protrusion extends into the slot to prevent compression of the tang.

20. A comfort aid according to claim 1 comprising the soother of claim 19.
